(19) United States
(12) Patent Application Publication
(10) Pub. No.: US 2007/0297362 A1
(43) Pub. Date: Dec. 27, 2007

(54) Radio communication system, system control unit, base station, communication control method, and program

(75) Inventors: Sadao Kimura, Tokyo (JP); Yasuhiro Mizukoshi, Tokyo (JP); Hideki Kurokawa, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/729,977

(22) Filed: Mar. 30, 2007

(30) Foreign Application Priority Data
Mar. 31, 2006 (JP) 099539/2006

(51) Int. Cl. H04Q 7/00

(52) U.S. Cl. 370/329

(57) ABSTRACT

A control unit collects transfer ability information of respective base stations, load information such as the number of mobile stations belonging to the base stations and a communication traffic amount, and information on base stations to which the respective mobile stations belong. When the control unit detects that a mobile station has moved across a sub-network, the control unit dynamically selects a transfer source base station that can keep a stable communication quality from a moving source sub-network to a moving destination sub-network, dynamically establishes a stable communication path between the sub-networks, and stably keeps a communication quality for the mobile station.

### BACKGROUND OF THE INVENTION

1. Field of the Invention

The present invention relates to a radio communication system that includes multiple base stations, distributed into a plurality of sub-networks, and a system control unit, base stations, a communication control method, and a computer program for the radio communication system.

2. Description of Related Art

Conventionally, in a wireless LAN system, when a mobile station that performs real-time video communication for treating sound and videos moves beyond a sub-network, it is necessary to set a communication path between an Access Point in a former sub-network and an Access Point in a destination sub-network in order to avoid changing an IP address of a mobile station.

A mobile station can be a cellular phone, a laptop computer, or other portable device capable of interacting with the base stations (access points) of a LAN system described herein. The terms “Access Point” and “base station” are used interchangeable.

The conventional wireless LAN system that establishes a continuous communication path for the mobile station will be explained with reference to FIG. 1.

First, a control unit 501 and an Access Point 502 recognize that the mobile station has moved beyond the sub-network.

In an example explained here, a mobile station 503 has moved to change a station, to which the mobile station 503 belongs, from an Access Point 502b to an Access Point 502c. The unit 501 establishes an inter-sub-network communication path 506 between the Access Point 502b, to which the mobile station 503 belonged immediately before moving beyond the sub-network, and the Access Point 502c, to which the mobile station 503 newly belongs.

In this way, when a mobile station moves beyond a sub-network, an Access Point, to which the mobile station belonged at the beginning, or an Access Point, to which the mobile station belonged immediately before moving across the sub-network, is selected. The selected base station transfers information from a former sub-network to a destination sub-network.

For example, document 1 (Japanese Patent Laid Open No. 2000-69050) discloses an Access Point that judges whether traffic has exceeded a threshold. When the traffic has exceeded the threshold, the base station judges presence or absence of a communication path candidate with reference to a topology map, judges whether it is possible to distribute the traffic by switching a communication path, and, when it is possible to distribute the traffic, switches the communication path.

However, in the conventional wireless LAN system, when the Access Point, to which the mobile station belonged last in the sub-network before movement, is selected as a transfer source Access Point that transfers information to the destination sub-network, an Access Point set in a location geographically close to a boundary (change point) of the sub-network tends to be selected. Thus, it is likely that loads tend to concentrate on the Access Point close to the change point of the sub-network and a stable communication quality might be difficult to obtain.

In the conventional wireless LAN system, when an Access Point, to which the mobile station belonged at the beginning, is selected as the transfer source Access Point, but the Access Point conducts wireless communication with control units, a transfer ability of the Access Point is generally lower than an Access Point conducting cable communication. Therefore, it is likely that a radio band becomes tighter and it is more difficult to preserve a stable communication quality.

As described above, in a conventional radio communication system, an Access Point used to establish a communication path is selected depending on a moving path of a mobile station and an initial position of the mobile station. Thus, loads concentrate on a specific Access Point, or an Access Point inappropriate to establish a communication path is selected. Therefore, a stable communication path may not be maintained.

Moreover, the Access Point disclosed in document 1, when a mobile station moves beyond a sub-network, changing an Access Point to an Access Point in a different sub-network, it is necessary to continue to create topology maps based on simulations. Thus, it is necessary to continue to use processing ability to establish a path between sub-networks. As a result, large loads are applied to the Access Points.

### SUMMARY OF THE INVENTION

In light of the foregoing problems, the present invention aims to provide a radio communication system, a system control unit, a base station, a communication control method, and a communication control program that dynamically select, even when a base station is changed to a base station of a different sub-network, an appropriate base station, and control processing loads for performing the dynamic selection to be small and effectively utilize processing ability, and guarantee a stable communication quality.

In order to solve these problems and achieve the above-described benefit, a radio communication system according to a first aspect of the present invention includes multiple base stations that control radio communication with a mobile station and a system control unit that performs various kinds of control in communication in the plural base stations. The plural base stations are divided into plural sub-networks. The radio communication system includes base station selecting means for selecting, when a base station, to which the mobile station belongs, is changed from a base station of one sub-network to a base station of a different sub-network, a transfer source base station for transferring information from a moving source sub-network to a moving destination sub-network out of base stations included in the moving source sub-network in accordance with a processing procedure decided in advance such that a specific base station is not preferentially selected.

It is preferable that the radio communication system includes base station information managing means for managing information on each of the plural base stations and the base station selecting means selects the transfer source base station on the basis of base station information of the base station information managing means.

It is preferable that the information on the base station managed by the base station information managing means includes at least transfer ability information of the base station and the base station selecting means selects the transfer source base station using the transfer ability information.

It is preferable that the information on the base station managed by the base station information managing means includes at least information on a communication traffic amount in the base station and the base station selecting means selects the transfer source base station on the basis of a margin of a transfer ability obtained by deducting the communication traffic amount of each of the base stations from a transfer ability of the base station managed by the base station information managing means.

It is preferable that the information on the base station managed by the base station information managing means includes at least information on the number of mobile stations belonging to each of the base stations and the base station selecting means selects the transfer source base station using the information on the number of mobile stations belonging to the base station.

It is preferable that the base station selecting means selects, as the transfer source base station, an base station having the margin of the transfer ability in a range from a maximum to a ratio set in advance and a smallest number of mobile stations belonging thereto among base stations included in the moving source sub-network.

The base station selecting means may select the transfer source base station out of the base stations included in the transfer source sub-network at random.

The base station selecting means may sequentially select the transfer source base station out of the base stations included in the moving source sub-network in accordance with an order set in advance.

A system control unit according to a second aspect of the present invention is a system control unit that is used in a radio communication system in which plural base stations are divided into plural sub-networks and performs various kinds of control in communication in the plural base stations. The radio communication system includes base station selecting means for selecting, when a base station, to which the mobile station belongs, is changed from a base station of one sub-network to a base station of a different sub-network, a transfer source base station for transferring information from a moving source sub-network to a moving destination sub-network out of base stations included in the moving source sub-network in accordance with a processing procedure decided in advance such that a specific base station is not preferentially selected.

It is preferable that the radio communication system includes base station information managing means for managing information on each of the plural base stations and the base station selecting means selects the transfer source base station on the basis of base station information of the base station information managing means.

It is preferable that the information on the base station managed by the base station information managing means includes at least transfer ability information of the base station and the base station selecting means selects the transfer source base station using the transfer ability information.

It is preferable that the information on the base station managed by the base station-information managing means includes at least information on a communication traffic amount in the base station and the base station selecting means selects the transfer source base station on the basis of a margin of a transfer ability obtained by deducting the communication traffic amount of each of the base stations from a transfer ability of the base station managed by the base station-information managing means.

It is preferable that the information on the base station managed by the base station-information managing means includes at least information on the number of mobile stations belonging to each of the base stations and the base station selecting means selects the transfer source base station using the information on the number of mobile stations belonging to the base station.

It is preferable that the base station selecting means selects, as the transfer source base station, a base station having the margin of the transfer ability in a range from a maximum to a ratio set in advance and a smallest number of mobile stations belonging thereto among base stations included in the moving source sub-network.

The base station selecting means may select the transfer source base station out of the base stations included in the transfer source sub-network at random.

The base station selecting means may sequentially select the transfer source base station out of the base stations included in the moving source sub-network in accordance with an order set in advance.

A base station according to a third aspect of the present invention is a base station used in a radio communication system that includes plural base stations and a system control unit that performs various kinds of control in communication in the plural base stations. The plural base stations are divided into plural sub-networks. The base station includes base station-information transmitting means for transmitting information on the base station to the system control unit and communication path securing means for securing a communication path, which connects different sub-networks, between the base station and a base station designated by the system control unit.

It is preferable that the information on the base station transmitted by the base station-information transmitting means includes at least information on a communication traffic amount of the base station.

It is preferable that the information on the base station transmitted by the base station-information transmitting means includes at least information on belonging of a mobile station to the base station.

A communication control method according to a fourth aspect of the present invention is a communication control method in a radio communication system including plural base stations that control radio communication with a mobile station and a system control unit that performs various kinds of control in communication in the plural base stations. The plural base stations are divided into plural sub-networks. The communication control method includes a change judging step of judging whether a base station, to which the mobile station belongs, is changed from a base station of one sub-network to a base station of a different sub-network and an base station selecting step of selecting, when it is judged in the change judging step that the base station, to which the mobile station belongs, is changed to an base station of a different sub-network, a transfer source base station for transferring information from a moving source sub-network to a moving destination sub-network out of base stations included in the moving source sub-network in accordance with a processing procedure decided in advance such that a specific base station is not preferentially selected.

It is preferable that, in the base station selecting step, the transfer source base station is selected on the basis of information on each of the plural base stations.

It is preferable that, in the base station selecting step, the transfer source base station is selected using at least transfer ability information of the base station.

It is preferable that, in the base station selecting step, the transfer source base station is selected on the basis of a margin of a transfer ability obtained by deducting communication traffic amount of each of the base stations from a transfer ability of the base station.

It is preferable that, in the base station selecting step, the transfer source base station is selected using at least information on the number of mobile stations belonging to the base station.

It is preferable that, in the base station selecting step, a base station having the margin of the transfer ability in a range from a maximum to a ratio set in advance and a smallest number of mobile stations belonging thereto among base stations included in the moving source sub-network is selected as the transfer source base station.

In the base station selecting step, the transfer source base station may be selected out of the base stations included in the transfer source sub-network at random.

In the base station selecting step, the transfer source base station may be sequentially selected out of the base stations included in the moving source sub-network in accordance with an order set in advance.

A communication control program according to a fifth aspect of the present invention is a communication control program in a radio communication system including plural base stations that control radio communication with a mobile station and a system control unit that performs various kinds of control in communication in the plural base stations. The plural base stations are divided into plural sub-networks. The communication control program causes a computer to execute change judging processing for judging whether a base station, to which the mobile station belongs, is changed from a base station of one sub-network to a base station of a different sub-network and base station selecting processing for selecting, when it is judged in the change judging processing that the base station, to which the mobile station belongs, is changed to an base station of a different sub-network, a transfer source base station for transferring information from a moving source sub-network to a moving destination sub-network out of base stations included in the moving source sub-network in accordance with a processing procedure decided in advance such that a specific base station is not preferentially selected.

It is preferable that, in the base station selecting processing, the transfer source base station is selected on the basis of information on each of the plural base stations.

It is preferable that, in the base station selecting processing, the transfer source base station is selected using at least transfer ability information of the base station. It is preferable that, in the base station selecting processing, the transfer source base station is selected on the basis of a margin of a transfer ability obtained by deducting communication traffic amount of each of the base stations from a transfer ability of the base station.

It is preferable that, in the base station selecting processing, the transfer source base station is selected using at least information on the number of mobile stations belonging to the base station.

It is preferable that, in the base station selecting processing, an base station having the margin of the transfer ability in a range from a maximum to a ratio set in advance and a smallest number of mobile stations belonging thereto among base stations included in the moving source sub-network is selected as the transfer source base station.

In the base station selecting processing, the transfer source base station may be selected out of the base stations included in the transfer source sub-network at random.

In the base station selecting processing, the transfer source base station may be sequentially selected out of the base stations included in the moving source sub-network in accordance with an order set in advance.

As described above, according to the present invention, it is possible to dynamically select, even when a base station, to which a mobile station belongs, is changed to a base station of a different sub-network, an appropriate base station as a transfer source base station for performing transfer from a moving source sub-network to a moving destination sub-network, control loads for performing the dynamic selection to be small and effectively utilize a processing ability, and guarantee a stable communication quality.

### BRIEF DESCRIPTION OF THE DRAWINGS

The exemplary purposes, aspects, and features of the present invention will become more apparent from the consideration of the following detailed description taken in conjunction with the accompanying drawings, in which:

FIG. 1 is a block diagram showing an example of a structure of the conventional radio communication system;

FIG. 2 is a block diagram showing an example of a structure of a radio communication system according to a first exemplary embodiment;

FIG. 3 is a diagram showing an example of an Access Point information table 11;

FIG. 4 is a diagram showing an example of a mobile station information table 14;

FIG. 5 is a sequence chart showing an operation of the radio communication system at the time when a mobile station moves beyond a sub-network;

FIG. 6 is a flowchart showing an Access Point selecting operation according to a control unit 1 according to the first embodiment;

FIG. 7 is a block diagram showing an example of a structure of a radio communication system according to a second exemplary embodiment;

FIG. 8 is a diagram showing an example of an Access Point information table 61;

FIG. 9 is a flowchart showing an Access Point selecting operation by the control unit 1 according to the second embodiment; and

FIG. 10 is a diagram showing another example of the Access Point information table 61.

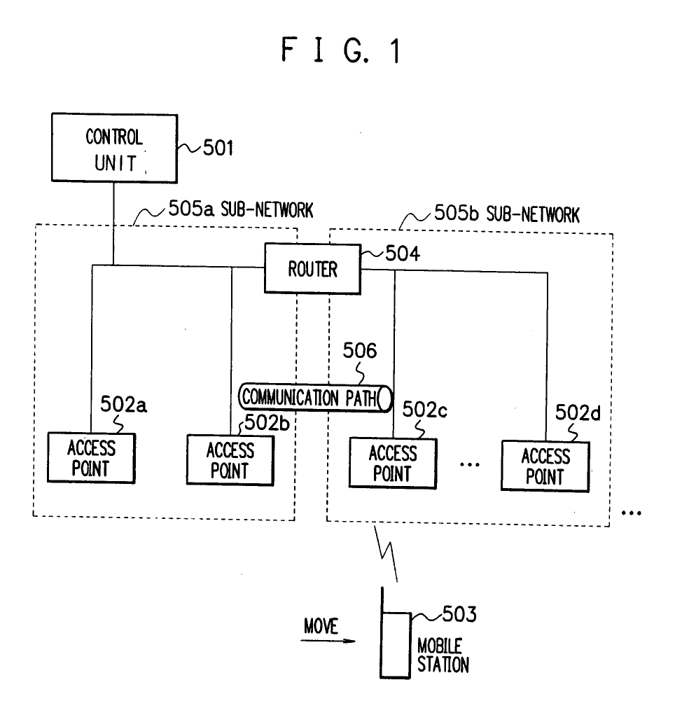

### DESCRIPTION OF THE EXEMPLARY EMBODIMENTS

Embodiments of a radio communication system, a system control unit, an Access Point, a communication control method, and a communication control program are explained in detail with reference to the accompanying drawings.

First, the exemplary embodiments will be schematically explained.

There is provided a wireless LAN system in which a mobile station freely moves in an area, in which plural Access Points (base stations) are set, and performs communication. The wireless LAN system has a function of selecting a stable communication path for the mobile station even when the mobile station moves beyond an area where routing is possible.

### First Embodiment

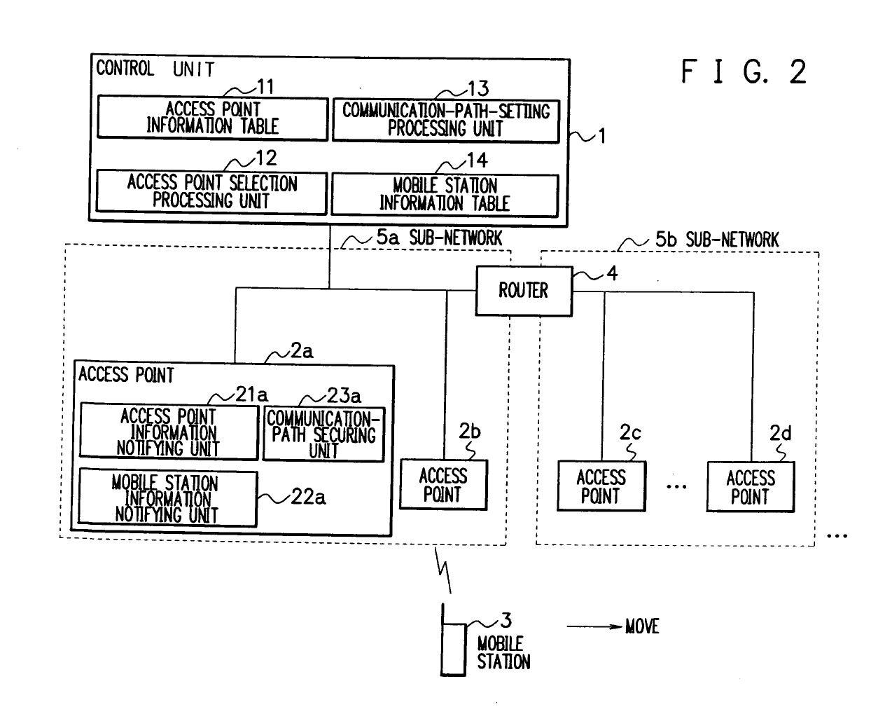

A radio communication system according to a first exemplary embodiment will be explained with reference to FIG. 2.

The radio communication system includes a control unit 1 and Access Points 2 (2a, 2b, 2c, . . . ). These Access Points 2 are grouped into sub-networks 5a and 5b, and address information is managed based on the sub-networks. The Access Points 2 are capable of communicating with one another via a router 4.

The control unit 1 includes an Access Point information table 11, an Access Point-selection processing unit 12, a communication-path-setting processing unit 13, and a mobile station information table 14.

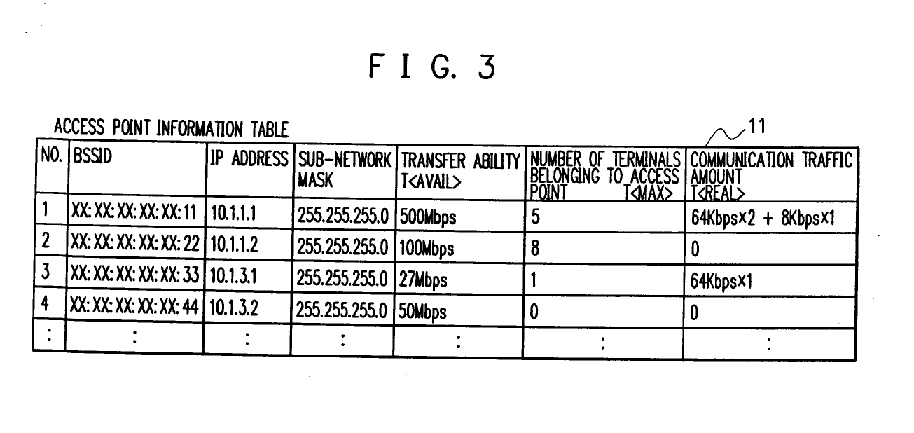

As shown in FIG. 3, the table 11 stores, for the respective Access Points 2 to be managed by the control unit 1, IP (Internet Protocol) addresses, sub-network mask information, transfer ability information, information on the number of mobile mobile stations belonging to each of the Access Points, and load information including a communication traffic amount in association with a BSSID (Basic Service Set Identifier) serving as a basic service identifier of an Access Point.

The unit 12 selects, on the basis of the information stored in the table 11, an Access Point optimum for a transfer source Access Point used to establish a communication path between sub-networks.

When a mobile station 3 moves beyond a sub-network, the unit 13 performs communication with a communication-path securing unit 23 included in the Access Point 2 and requests the unit 23 to set a communication path between a transfer source Access Point in an initial sub-network and a new Access Point in a destination sub-network.

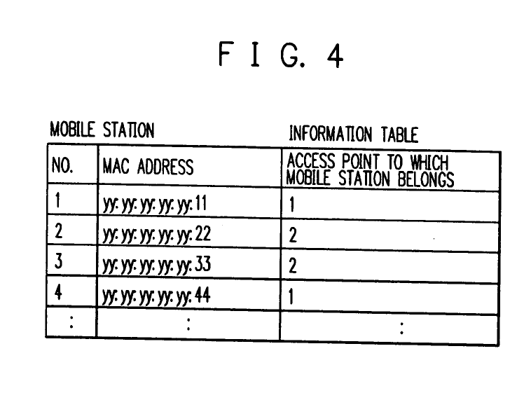

As shown in FIG. 4, the table 14 manages an individual identifier MAC (Media Access Control) address of each mobile station 3 belonging to the Access Point 2 to judge movement of the mobile station 3.

Each of Access Points 2 includes an Access Point-information notifying unit 21, a mobile station-information notifying unit 22, and a communication-path securing unit 23.

The unit 21 manages transfer ability information, IP addresses, sub-network information, and a basic service identifier BSSID of the Access Point 2 and notifies the control unit 1 of the transfer ability information, the IP addresses, the sub-network information, and the basic service identifier BSSID.

When the mobile station 3 belongs to the Access Point 2 and when the mobile station 3 begins communication, the unit 22 notifies the control unit 1 accordingly.

The unit 23 establishes an inter-sub-network communication path between the Access Point 2 and a designated Access Point according to a request from the unit 13.

Operations by the radio communication system will be schematically explained with reference to FIG. 2.

For example, after the mobile station 3 belongs to the Access Point 2b in the sub-network 5a for the first time, when the mobile station 3 moves beyond the sub-network and newly establishes communication with the Access Point 2c in the sub-network 5b, to maintain communication, it is necessary to set a communication path between an Access Point in the sub-network 5a and the Access Point 2c.

The control unit 1 manages information concerning mobile stations belonging to the Access Points 2 (2a, 2b, 2c, . . . ). The information includes communication load information such as the number of mobile stations belonging to Access Points and an amount of communication traffic, sub-network information, and transfer ability information of the Access Points.

When the mobile station 3 newly belongs to the Access Point 2c, the base station 2c transfers an association request message, which is transmitted when a mobile station belongs to an Access Point, to the control unit 1.

The control unit 1 recognizes, from the association request message transferred from the Access Point 2c and the table 1, that the mobile station 3 has moved beyond a sub-network, and detects a sub-network to which the mobile station 3 belonged before the movement.

The unit 12 selects, on the basis of the transfer ability information of the Access Points and the load information of the Access Points, an Access Point (“transfer source Access Point”) that forms an inter-sub-network communication path from among the Access Points 2 (in the example in FIG. 2, the Access Points 2a and 2b) in the sub-network 5a.

A communication path is established between the transfer source Access Point selected in this way and the Access Point 2c. Consequently, even when the mobile station 3 moves beyond a sub-network, it is possible to maintain a stable communication state.

In general, in a wireless communication system, when a mobile station, in particular, a mobile station that performs real-time video communication for handling sound and videos moves beyond a sub-network, in order to continue communication without changing an IP address of the mobile station, it is necessary to set a communication path that connects a sub-network in which the mobile station obtained an address with a sub-network to which the mobile station moves.

In this embodiment, in setting such a communication path, the control unit 1, which manages a group of Access Points that provide radio access to mobile stations, collects transfer ability information of the respective Access Points, load information such as the number of mobile stations belonging to the Access Points and a communication traffic amount, and information on Access Points to which the respective mobile stations belong. The transfer ability information may be input from a user.

By collecting such information, when the control unit 1 detects that a mobile station has moved beyond a sub-network, the control unit 1 dynamically selects a transfer source Access Point that can keep a stable communication quality from an initial sub-network to a destination sub-network, dynamically establishes a stable communication path between the sub-networks, and stably provides a communication quality for the mobile station.

Operations of the radio communication system according to this embodiment will be explained with reference to FIGS. 2 to 5.

When the control unit 1 starts to control the respective Access Points 2, the control unit 1 acquires basic service identifiers BSSID, IP addresses, sub-network masks, transfer ability information of the Access Points, the number of mobile stations belonging to the Access Points, communication traffic amounts, and individual information identifier MAC addresses of the mobile stations belonging to the Access Points via the units 21 and the units 22 of the Access Points 2.

In this way, the control unit 1 gathers initial information for the table 11 and the table 14 and manages the information.

Transmission ability T<avail> of the Access Points stored in the table 11 is not limited to default transfer ability information notified from the units 21 of the Access Points 2. The user may set the transfer ability. Therefore, an administrator of the network can set the transfer ability appropriately according to an operation policy of the network.

For example, an Access Point that communicates with control units wirelessly, compared with an Access Point that is connected to a network through cables, is likely to provide a slower communication speed than a theoretical value, influenced by communication errors or an environment. In such a case, the transfer ability T<avail> of the Access Point is set considerably lower than the theoretical value, in advance, whereby higher priority may be given to the Access Point connected to the network with wire. As a result, a transfer source Access Point is more accurately selected. The number of mobile stations belonging to an Access Point (T<max>) and a communication traffic amount (T<real>) are updated at any time when the number of mobile stations belonging to the Access Point 2 changes and when communication starts and ends according to transmission of information from the unit 21 of the Access Point 2 to the control unit 1.

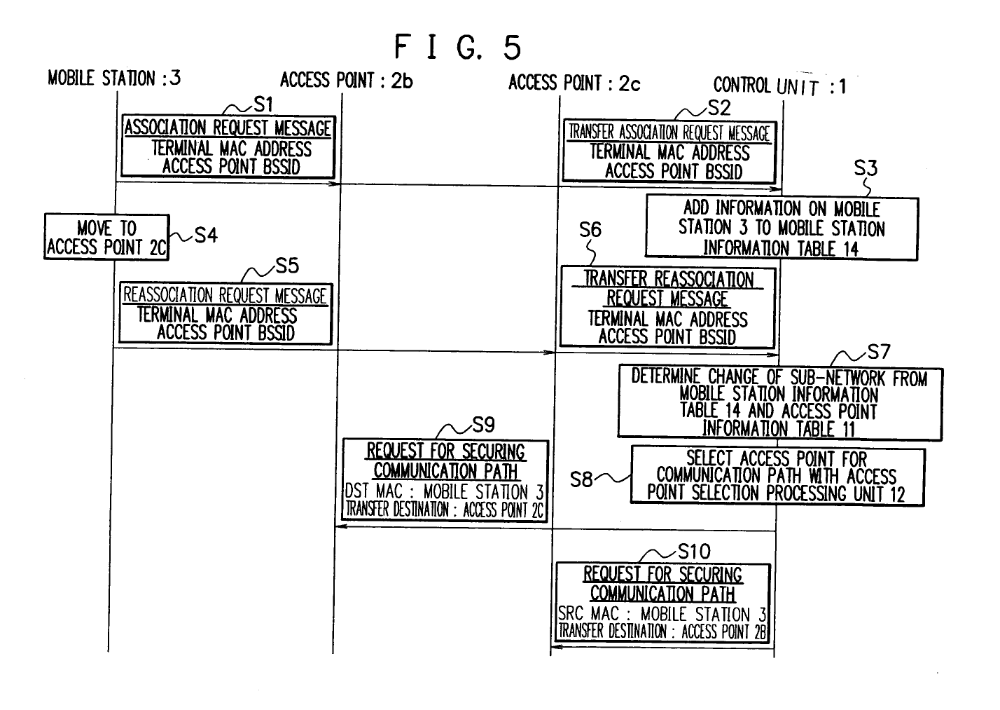

A control sequence from the time when the mobile station 3 is turned on is shown in FIG. 5.

When the mobile station 3 is turned on, the mobile station 3 selects one of Access Points set around the mobile station 3 and transmits an association request message including an MAC address (step S1). In an example explained here, the Access Point 2b is selected as an Access Point to which the mobile station 3 initially belongs.

The Access Point 2b transfers the association request message received to the control unit 1 as a transfer association request message (step S2).

The control unit 1 updates, on the basis of the transfer association request message received, the table 14 to associate identification information of the Access Point, to which the mobile station 3 belongs, with the MAC address (step S3).

When the connection of the mobile station 3 to the Access Point 2b is completed, an IP address of a sub-network to which the Access Point 2b belongs is given to the mobile station 3.

When the mobile station 3 moves, belonging to the Access Point 2b, into a communication zone of the Access Point 2c beyond a communication zone of Access Point 2b (step S4), the mobile station 3 transmits a reassociation request message to the Access Point 2c (step S5).

The Access Point 2c transfers the reassociation request message to the control unit 1 as a transfer reassociation request message (step S6).

The control unit 1 recognizes that the mobile station 3 has moved with reference to the table 14 according to an MAC address and a BSSID of the Access Point included in the transfer reassociation request message.

The control unit 1, which has recognized the movement of the mobile station 3, acquires information on the Access Points 2b and 2c before and after the movement from the table 11 and compares IP addresses of the Access Points and sub-network information to judge whether the mobile station 3 has moved beyond a sub-network (step S7).

When it is judged that the mobile station 3 has moved beyond a sub-network, the control unit 1 (the unit 12) selects a transfer source Access Point out of the Access Points 2 included in the initial sub-network (step S8).

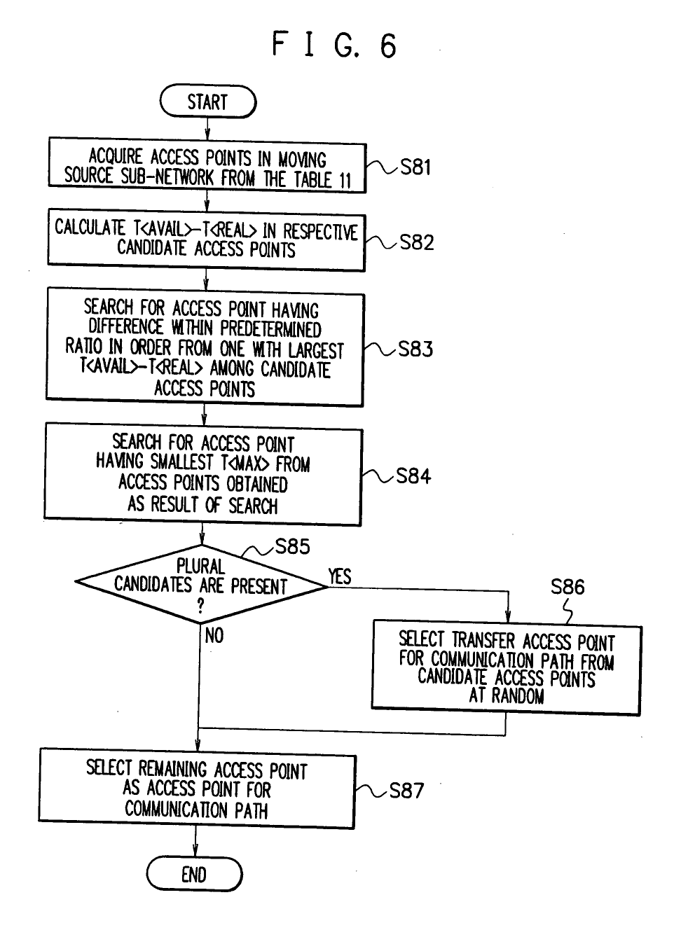

This operation for selecting a transfer source Access Point will be explained with reference to the flowchart in FIG. 6.

First, the control unit 1 acquires a list of Access Points included in the sub-network 5a from the table 11 (step S81). In the example shown in FIG. 2, the Access Points are the Access Points 2a and 2b.

Concerning the respective Access Points 2, the unit 12 calculates transfer ability T<avail>—communication traffic amount T<real> (step S82).

The unit 12 compares the values (transfer ability T<avail> minus communication traffic amount T<real>) of the Access Points 2, i.e., margin information of a transfer ability of the Access Points, and searches for the Access Points 2 having a difference, for example, more than a predetermined value (step S83).

For the Access Points 2 found as a result of the search, the unit 12 searches for the Access Point 2 having a minimum T<max> (number of mobile stations belonging to the Access Point 2) (step S84). If the Access Points 2 are narrowed down to one Access Point (step S85; No), the unit 12 selects the Access Point 2 as a transfer source Access Point (step S87).

When there still remains a plurality of possible Access Points 2 (step S85; Yes), the unit 12 selects a transfer source Access Point out of the Access Points at random (steps S86 and S87).

In this way, the Access Point 2 that has a margin of transfer ability suitable for use as a communication path and a small number of mobile stations belonging thereto is selected as a transfer source Access Point.

In the example of the operations in FIG. 5, it is assumed that the Access Point 2b is selected.

The unit 13 of the control unit 1 transmits a communication path securing request to the Access Point 2b selected as described above so that the station 2b transfers data addressed to the mobile station 3 to the station 2c (step S9). Similarly, the unit 13 transmits a communication path securing request to the station 2c so that the station 2c transfers to the station 2b data sent from the mobile station 3 (step S10).

In this way, even when the mobile station 3 moves beyond a sub-network, it is possible to select a transfer source Access Point that is optimal for transferring information from an initial sub-network to a destination sub-network and to establish a communication path for the mobile station 3.

As explained above, according to this embodiment, a transfer source Access Point for securing a communication path for a mobile station is selected on the basis of a margin of transfer ability calculated from transfer ability T<avail> minus communication traffic amount T<real>, and the number of mobile stations belonging to a base station. Thus, it is possible to continue to provide a stable communication path even when the mobile station 3 moves beyond a sub-network, and to guarantee a stable communication quality for the mobile station.

The user may set the transfer ability T<avail> in the table 11 used for selecting a transfer source Access Point. Thus, according to a setting state of Access Points and an operation policy of a network, the user may freely set parameters so that a transfer source Access Point is selected more appropriately.

Therefore, even when a setting state of Access Points are complicated, or it is desired to reflect an operation policy of a network, it is possible to appropriately select a transfer source Access Point without concentrating loads on a specific Access Point, and to establish a stable communication path. Even when the mobile station 3 moves beyond a sub-network, it is possible to maintain a stable communication quality.

In this way, even when an Access Point to which a mobile station belongs is changed to an Access Point in a different sub-network, it is possible to connect an initial sub-network and a destination sub-network without changing an IP address and to dynamically select an Access Point appropriately.

Simply by finding a transfer source Access Point from the table 11, when necessary, it is possible to appropriately perform such dynamic selection of a transfer source Access Point such that a single specific Access Point is not selected again and again (e.g., preferentially). Thus, it is possible to control loads for performing the dynamic selection to be small, effectively utilize a processing ability and keeping a stable communication quality.

### Second Embodiment

A radio communication system according to a second exemplary embodiment will be explained.

In the first embodiment, when the mobile station 3 moves beyond a sub-network, a transfer source Access Point is selected on the basis of a margin of transfer ability and the number of mobile stations belonging to an Access Point. In the second exemplary embodiment, a transfer source Access Point is selected at random or in accordance, thereby also precluding preferential selection with an order set in advance.

Components same as those in the first embodiment are denoted by the same reference numerals and signs, and explanations of the components are omitted.

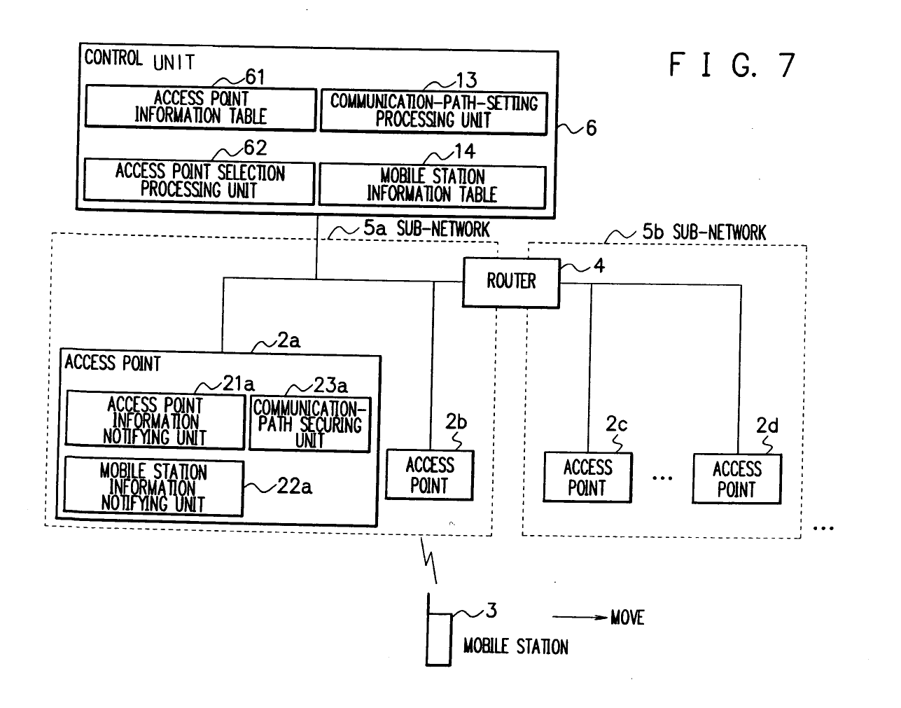

As shown in FIG. 7, the control unit 1 according to the second embodiment includes an Access Point information table 61, an Access Point-selection processing unit 62, the communication-path-setting processing unit 13, and the mobile station information table 14.

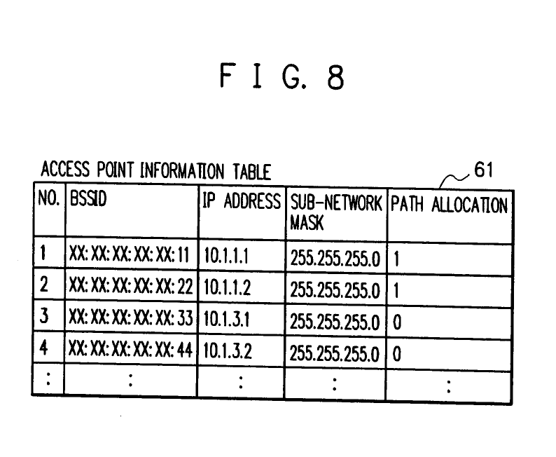

As shown in FIG. 8, the table 61 stores, for the respective Access Points 2 to be managed by the control unit 1, an IP address, sub-network mask information, number of times of path allocation information in association with a BSSID serving as a basic service identifier of an Access Point.

The unit 62 selects, on the basis of the information stored in the table 61, an Access Point optimum for a transfer source Access Point used for a communication path between sub-networks.

Operations of the radio communication system according to this embodiment will be explained.

Operations from the time when the mobile station 3 is turned on are the same as the operations in the first embodiment explained with reference to FIG. 5 except an operation for selecting a transfer source Access Point indicated in step S8. Thus, explanations of the overlapping operations are omitted.

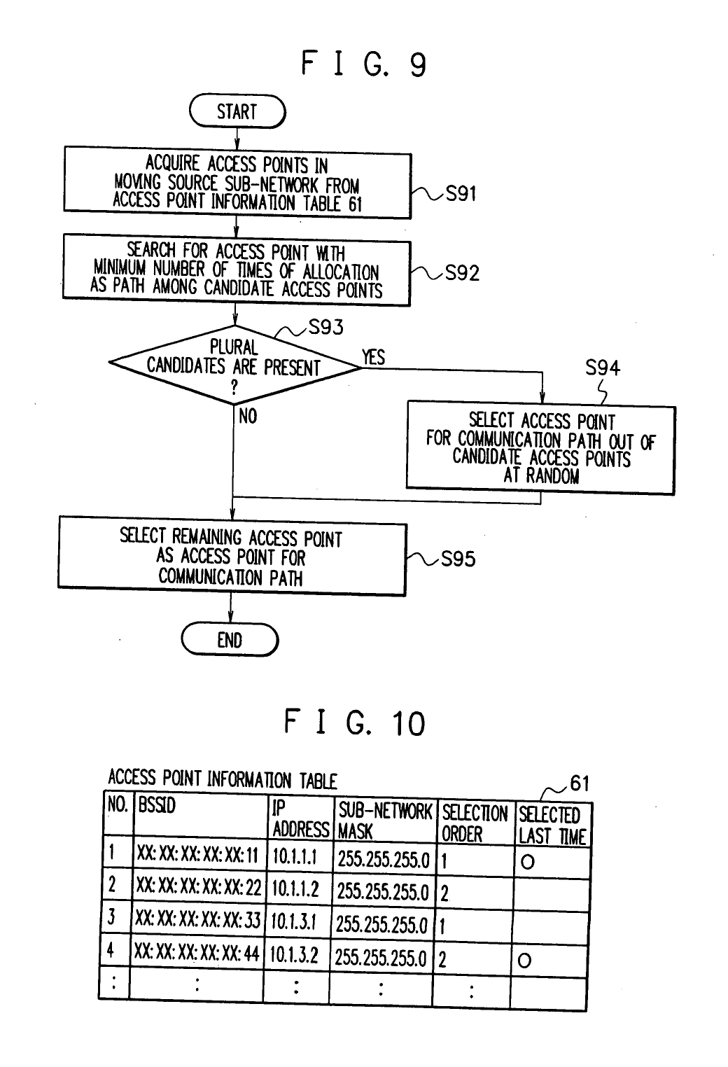

An operation for selecting a transfer source Access Point will be explained with reference to the flowchart in FIG. 9.

First, the control unit 1 acquires a list of Access Points included in the sub-network 5a from the table 61 (step S91). The mobile station 3 first belonged to the Access Point 2b in the sub-network 5a. In the example shown in FIG. 7, the Access Points are the Access Points 2a and 2b.

Concerning the Access Points 2 acquired in this way, the unit 62 searches for an Access Point 2 having a minimum number for path allocations in the table 61, i.e., an Access Point 2 that has been least selected as a transfer source Access Point (step S92).

When there is a plurality of Access Points 2 found as a result of the search (step S93; Yes), the unit 62 selects a transfer source Access Point from the Access Points at random (steps S94 and S95). For this random selection, various methods may be used, such as, for example, use of a table of random numbers.

When candidate Access Points 2 are narrowed down to one Access Point according to the search in step S92 (step S93: No), the processing unit 62 selects the Access Point 2 as a transfer source Access Point (step S95).

As described above, when the mobile station 3 moves beyond a sub-network, a transfer source Access Point for transferring information from an initial sub-network to the Access Point 2c in a destination sub-network is selected from among the Access Points included in the initial sub-network at random.

In this way, according to the second embodiment, a transfer source Access Point for securing a communication path for a mobile station is selected from among the Access Points included in the initial sub-network at random. Thus, even when the mobile station 3 moves beyond a sub-network, it is possible to connect an initial sub-network and a destination sub-network without changing an IP address, and select a transfer source Access Point in a manner that a single specific Access Point is not repeatedly selected. It is also possible to continue to provide a stable communication path.

Therefore, it is also possible to maintain a stable communication quality for mobile stations.

Moreover, simply by finding a transfer source Access Point from the table 61 when the selection is necessary, it is possible to appropriately perform such dynamic selection of a transfer source Access Point in a manner that a single specific Access Point is not repeatedly selected. Thus, it is possible to distribute loads for performing the dynamic selection, effectively utilize a processing ability and maintain a stable communication quality.

In the explanation of the exemplary operations, a transfer source Access Point is selected at random. However, a transfer source Access Point may also be selected in turn, in accordance with a predetermined order.

In this case, in the table 61, as shown in FIG. 10, an IP address, sub-network mask information, and selection order information are stored in association with a basic service identifier BSSID of an Access Point and a flag is set on an Access Point that was selected last time.

This selection order begins at “1” for each sub-network. The user may arbitrarily set a selection order.

According to such a constitution, when Access Points 2 included in the initial sub-network is searched for in step S91, an Access Point whose order follows the previously selected Access Point is next selected as a transfer source Access Point by selection unit 62.

In this way, according to the operation for sequentially selecting a transfer source Access Point in accordance with an order set in advance in the second embodiment, it is also possible to select a transfer source Access Point such that specific base radio stations are not repeatedly selected. It is possible to continue to provide a stable communication path.

Therefore, a stable communication quality for a mobile station is also provided.

Moreover, simply by finding a transfer source Access Point from the table 61 when the selection is necessary, it is possible to appropriately perform such dynamic selection of a transfer source Access Point such that only specific Access Points are not selected. Thus, loads for performing the dynamic selection is reduced and distributed, a processing ability is effectively used, and a stable communication quality is maintained.

The embodiments described above are exemplary embodiments. However, the present invention is not limited to these embodiments. It is possible to modify and carry out the embodiments in various ways on the basis of the technical idea of the present invention.

For example, the number of sub-networks that divide Access Points and the number of Access Points included in each sub-network are not limited to those described above and may be increased.

In the explanations of the embodiments, one control unit is used. However, a plurality of control units 1 may be connected.

Namely, when the mobile station 3 switches Access Points after the mobile station 3 moves beyond the original cell to a new cell of another control unit, it is also possible to realize the operations according to the embodiments by exchanging the information of the table 11 and the table 14 between a control unit of the original cell and a control unit of a new cell.

When the processing for realizing the radio communication systems according to the embodiments are tangibly recorded in a recording medium as a program, it is possible to realize the functions according to the embodiments by causing a CPU of a computer constituting the system to execute the processing according to the program supplied from the recording medium.

In this case, the present invention is also applied when an information group including the program is supplied to an output unit from the recording medium or from an external recording medium via a network.

A program code itself read out from the recording medium executes the novel functions of the present invention. The recording medium having stored therein the program code and a signal read out from the recording medium, thereby can implement the present invention.

As the recording medium, for example, a floppy disk, a hard disk, an optical disk, a magneto-optical disk, a CD-ROM, a CD-R, a magnetic tape, a nonvolatile memory card, a ROM, an EEPROM, and the like may be used.

In this aspect, in the program according to the present invention, it is possible to cause a computer controlled by the program to realize the functions in the radio communication system according to the exemplary embodiments.

What is claimed is:

1. A radio communication system, comprising
base stations that control radio communication with a mobile station and are spread into a plurality of sub-networks; and
a system control unit that performs various kinds of control in communications in the base stations;
base station selecting means for selecting, when a base station, to which the mobile station belongs, is changed from a base station of one sub-network to a base station of another sub-network, a transfer source base station for transferring information from a moving source sub-network to a moving destination sub-network, out of base stations included in the moving source sub-network, in accordance with a processing procedure decided in advance, such that a specific base station is not preferentially selected.

2. The radio communication system according to claim 1, further comprising base station information managing means for managing information on each of the base stations, wherein
the base station selecting means selects the transfer source base station on the basis of base station information of the base station information managing means.

3. The radio communication system according to claim 2, wherein
the information on the base station managed by the base station information managing means includes at least a transfer ability information of the base station, and
the base station selecting means selects the transfer source base station using the transfer ability information.

4. The radio communication system according to claim 3, wherein
the information on the base station managed by the base station information managing means includes at least information on a communication traffic amount in the base station, and
the base station selecting means selects the transfer source base station on a basis of a margin of a transfer ability obtained by deducting the communication traffic amount of each of the base stations from a transfer ability of the base station managed by the base station information managing means.

5. The radio communication system according to claim 4, wherein
the information on the base station managed by the base station information managing means includes at least information on a number of mobile stations belonging to each of the base stations, and
the base station selecting means selects the transfer source base station using the information on the number of mobile stations belonging to the base station.

6. The radio communication system according to claim 5, wherein the base station selecting means selects, as the transfer source base station, a base station having the margin of the transfer ability in a range from a maximum to a ratio set in advance and a smallest number of mobile stations belonging thereto among base stations included in the moving source sub-network.

7. The radio communication system according to claim 1, wherein the base station selecting means selects the transfer source base station out of the base stations included in the transfer source sub-network at random.

8. The radio communication system according to claim 1, wherein the base station selecting means sequentially selects the transfer source base station out of the base stations included in the moving source sub-network in accordance with an order set in advance.

9. A system control unit that is used in a radio communication system in which base stations are spread into a plurality of sub-networks and performs various kinds of control in communication in the base stations, comprising base station selecting means for selecting, when a base station, to which the mobile station belongs, is changed from a base station of one sub-network to a base station of a different sub-network, a transfer source base station for transferring information from a moving source sub-network to a moving destination sub-network, out of base stations included in the moving source sub-network, in accordance with a processing procedure decided in advance, such that a specific base station is not preferentially selected.

10. The system control unit according to claim 9, further comprising base station information managing means for managing information on each of the base stations, wherein
the base selecting means selects the transfer source base station on a basis of base station information of the base station information managing means.

11. The system control unit according to claim 10, wherein
the information on the base station managed by the base station information managing means includes at least a transfer ability information of the base station, and
the base station selecting means selects the transfer source base station using the transfer ability information.

12. The system control unit according to claim 11, wherein
the information on the base station managed by the base station information managing means includes at least information on a communication traffic amount in the base station, and
the base station selecting means selects the transfer source base station on a basis of a margin of a transfer ability obtained by deducting the communication traffic amount of each of the base stations from a transfer ability of the base station managed by the base station information managing means.

13. The system control unit according to claim 12, wherein
the information on the base station managed by the base station information managing means includes at least information on a number of mobile stations belonging to each of the base stations, and
the base station selecting means selects the transfer source base station using the information on the number of mobile stations belonging to the base station.

14. The system control unit according to claim 13, wherein the base station selecting means selects, as the transfer source base station, a base station having the margin of the transfer ability in a range from a maximum to a ratio set in advance and a smallest number of mobile stations belonging thereto among base stations included in the moving source sub-network.

15. The system control unit according to claim 9, wherein the base station selecting means selects the transfer source base station out of the base stations included in the transfer source sub-network at random.

16. The system control unit according to claim 9, wherein the base station selecting means sequentially selects the transfer source base station out of the base stations included in the moving source sub-network in accordance with an order set in advance.

17. A base station used in a radio communication system that includes base stations and a system control unit that performs various kinds of control in communication in the base stations, the base stations being spread into a plurality of sub-networks, the base station comprising:
base station information transmitting means for transmitting information on the base station to the system control unit; and
communication path securing means for securing a communication path, which connects different sub-networks, between the base station and a base station designated by the system control unit.

18. The base station according to claim 17, wherein the information on the base station transmitted by the base station information transmitting means includes at least information on a communication traffic amount of the base station.

19. The base station according to claim 17, wherein the information on the base station transmitted by the base station information transmitting means includes at least information on a belonging of a mobile station to the base station.

20. A communication control method in a radio communication system including base stations that control radio communication with a mobile station and a system control unit that performs various kinds of control in communication in the base stations, the base stations being spread into a plurality of sub-networks, the communication control method comprising:
a change judging step of judging whether a base station, to which the mobile station belongs, is changed from a base station of one sub-network to a base station of a different sub-network; and
a base station selecting step of selecting, when it is judged in the change judging step that the base station to which the mobile station belongs is changed to a base station of a different sub-network, a transfer source base station for transferring information from a moving source sub-network to a moving destination sub-network out of base stations included in the moving source sub-network in accordance with a processing procedure decided in advance, such that a specific base station is not preferentially selected.

21. The communication control method according to claim 20, wherein, in the base station selecting step, the transfer source base station is selected on a basis of information on each of the base stations.

22. The communication control method according to claim 21, wherein, in the base station selecting step, the transfer source base station is selected using at least transfer ability information of the base station.

23. The communication control method according to claim 22, wherein, in the base station selecting step, the transfer source base station is selected on a basis of a margin of a transfer ability obtained by deducting a communication traffic amount of each of the base stations from a transfer ability of the base station.

24. The communication control method according to claim 23, wherein, in the base station selecting step, the transfer source base station is selected using at least information on a number of mobile stations belonging to the base station.

25. The communication control method according to claim 24, wherein, in the base station selecting step, a base station having the margin of the transfer ability in a range from a maximum to a ratio set in advance and a smallest number of mobile stations belonging thereto among base stations included in the moving source sub-network is selected as the transfer source base station.

26. The communication control method according to claim 20, wherein, in the base station selecting step, the transfer source base station is selected out of the base stations included in the transfer source sub-network at random.

27. The communication control method according to claim 20, wherein, in the base station selecting step, the transfer source base station is sequentially selected out of the base stations included in the moving source sub-network in accordance with an order set in advance.

28. A computer program tangibly embodied in a machine-readable medium for controlling a radio communication system including base stations that control radio communication with a mobile station and a system control unit that performs various kinds of control in communication in the base stations, the base stations being spread into a plurality of sub-networks, the computer program causing a computer to execute:
change judging processing for judging whether a base station, to which the mobile station belongs, is changed from a base station of one sub-network to a base station of a different sub-network; and
base station selecting processing for selecting, when it is judged in the change judging processing that the base station, to which the mobile station belongs, is changed to a base station of a different sub-network, a transfer source base station for transferring information from a moving source sub-network to a moving destination sub-network, out of base stations included in the moving source sub-network, in accordance with a processing procedure decided in advance, such that a specific base station is not preferentially selected.

29. The computer program according to claim 28, wherein, in the base station selecting processing, the transfer source base station is selected on a basis of information on each of the base stations.

30. The computer program according to claim 29, wherein, in the base station selecting processing, the transfer source base station is selected using at least transfer ability information of the base station.

31. The computer program according to claim 30, wherein, in the base station selecting processing, the transfer source base station is selected on a basis of a margin of a transfer ability obtained by deducting a communication traffic amount of each of the base stations from a transfer ability of the base station.

32. The computer program according to claim 31, wherein, in the base station selecting processing, the transfer source base station is selected using at least information on a number of mobile stations belonging to the base station.

33. The computer program according to claim 32, wherein, in the base station selecting processing, a base station having the margin of the transfer ability in a range from a maximum to a ratio set in advance and a smallest number of mobile stations belonging thereto among base station included in the moving source sub-network is selected as the transfer source base station.

34. The computer program according to claim 28, wherein, in the base station selecting processing, the transfer source base station is selected out of the base stations included in the transfer source sub-network at random.

35. The computer program according to claim 28, wherein, in the base station selecting processing, the transfer source base station is sequentially selected out of the base stations included in the moving source sub-network in accordance with an order set in advance.
